(19) United States
(12) Patent Application Publication
(10) Pub. No.: US 2017/0124518 A1
(43) Pub. Date: May 4, 2017

(54) FACILITATING MEETINGS

(71) Applicant: Google Inc., Mountain View, CA (US)

(72) Inventors: Matthew John LESKE, Stockholm (SE); Ivan BERTONA, Stockholm (SE); Xiaohui CHEN, Sunnyvale, CA (US); Arthur van der GEER, Lulea (SE); David Scrymgeour BENNETT, Snohomish, WA (US)

(73) Assignee: GOOGLE INC., Mountain View, CA (US)

(21) Appl. No.: 14/103,087

(22) Filed: Dec. 11, 2013

Related U.S. Application Data
(60) Provisional application No. 61/910,024, filed on Nov. 27, 2013.

(51) Int. Cl. G06Q 10/10

(52) U.S. Cl. CPC G06Q 10/1095

(57) ABSTRACT

Implementations generally relate to facilitating meetings. In some implementations, a method includes receiving a meeting request for a meeting. The method further includes generating a calendar entry identifier in response to the meeting request. The method further includes associating the calendar entry identifier with a calendar entry. The method further includes verifying one or more requests to join the meeting against the calendar entry identifier.

### BACKGROUND

Video conferencing is often used in business settings, and enables participants to participate in virtual meetings in real-time across geographically dispersed locations. To set up a meeting, a meeting organizer typically provides meeting invitees with a conference dial-in number and a conference code. Each invitee can join the meeting by dialing in using the dial-in number and entering the conference code when prompted.

### SUMMARY

Implementations generally relate to facilitating meetings. In some implementations, a method includes receiving a meeting request for a meeting. The method further includes generating a calendar entry identifier in response to the meeting request. The method further includes associating the calendar entry identifier with a calendar entry. The method further includes verifying one or more requests to join the meeting against the calendar entry identifier.

With further regard to the method, in some implementations, each request to join the meeting includes an invitee identifier and a calendar entry identifier to be verified. In some implementations, the calendar entry identifier includes a meeting name and a code. In some implementations, the calendar entry identifier includes a meeting name and a code, and where the code is verified against the calendar entry identifier if the invitee is an external invitee. In some implementations, the method further includes enabling a meeting initiator to control invitee access to the meeting by modifying an access list associated with the calendar entry. In some implementations, the method further includes enabling a meeting initiator to control invitee access to the meeting by modifying an access list associated with the calendar entry, where the modifying of the access list includes adding or removing one or more invitees from the access list. In some implementations, the method further includes sending one or more invitations to one or more respective invitees, where each invitation includes an invitee identifier and a calendar entry identifier to be verified. In some implementations, the method further includes: notifying a meeting initiator and one or more internal invitees of any one or more external invitees requesting to join the meeting; and enabling the meeting initiator and any one or more of the internal invitees to approve or reject one or more requests to join the meeting. In some implementations, the method further includes: notifying a meeting initiator and one or more internal invitees of any one or more external invitees requesting to join the meeting; enabling the meeting initiator and any one or more of the internal invitees to approve or reject one or more requests to join the meeting; and enabling the meeting initiator and any one or more of the internal invitees to remove access to the meeting for any one or more external invitees even after the one or more external invitees has already joined the meeting.

In some implementations, a method includes: receiving a meeting request for a meeting; generating a calendar entry identifier in response to the meeting request; associating the calendar entry identifier with a calendar entry; sending one or more invitations to one or more respective invitees, where each invitation includes an invitee identifier and a calendar entry identifier to be verified; and verifying one or more requests to join the meeting against the calendar entry identifier, where each request to join the meeting includes an invitee identifier and a calendar entry identifier to be verified.

With further regard to the method, in some implementations, the method further includes enabling a meeting initiator to control invitee access to the meeting by modifying an access list associated with the calendar entry. In some implementations, the method further includes enabling a meeting initiator to control invitee access to the meeting by modifying an access list associated with the calendar entry, where the modifying of the access list includes adding or removing one or more invitees from the access list. In some implementations, the method further includes: notifying a meeting initiator and one or more internal invitees of any one or more external invitees requesting to join the meeting; and enabling the meeting initiator and any one or more of the internal invitees to approve or reject one or more requests to join the meeting.

In some implementations, a system includes one or more processors, and logic encoded in one or more tangible media for execution by the one or more processors. When executed, the logic is operable to perform operations including: receiving a meeting request for a meeting; generating a calendar entry identifier in response to the meeting request; associating the calendar entry identifier with a calendar entry; and verifying one or more requests to join the meeting against the calendar entry identifier.

With further regard to the system, in some implementations, each request to join the meeting includes an invitee identifier and a calendar entry identifier to be verified. In some implementations, the calendar entry identifier includes a meeting name and a code. In some implementations, the calendar entry identifier includes a meeting name and a code, and where the code is verified against the calendar entry identifier if the invitee is an external invitee. In some implementations, the logic when executed is further operable to perform operations including enabling a meeting initiator to control invitee access to the meeting by modifying an access list associated with the calendar entry. In some implementations, the logic when executed is further operable to perform operations including enabling a meeting initiator to control invitee access to the meeting by modifying an access list associated with the calendar entry, where the modifying of the access list includes adding or removing one or more invitees from the access list. In some implementations, the logic when executed is further operable to perform operations including sending one or more invitations to one or more respective invitees, where each invitation includes an invitee identifier and a calendar entry identifier to be verified.

### BRIEF DESCRIPTION OF THE DRAWINGS

FIG. 1 illustrates a block diagram of an example network environment, which may be used to implement the implementations described herein.

FIG. 2 illustrates an example simplified flow diagram for facilitating meetings, according to some implementations.

FIG. 3 illustrates a data flow diagram, according to some implementations.

FIG. 4 illustrates a block diagram of an example server device, which may be used to implement the implementations described herein.

### DETAILED DESCRIPTION

Implementations described herein facilitate meetings. In various implementations, a system generates a calendar entry identifier in response to receiving a request for a meeting. In some implementations, the calendar entry identifier includes a meeting name and a code. The system automatically generates a meeting name, which the meeting organizer/initiator can later change. The system associates the calendar entry identifier with a calendar entry. The system sends one or more invitations to one or more respective invitees, where each invitation includes an invitee identifier (e.g., an email address) and a calendar entry identifier to be verified. In some implementations, each request to join the meeting includes an invitee identifier and a calendar entry identifier to be verified. In various implementations, the system verifies requests to join the meeting against the calendar entry identifier.

As described in more detail below, in various implementations, the system enables the meeting initiator to invite invitees to join the meeting and later un-invite particular invitees for various reasons. Also, as described in more detail below, the system enables the meeting initiator or other invitees who are in the same organization (e.g., same company) to allow particular external invitees to join a given meeting and later remove access to the meeting for various reasons.

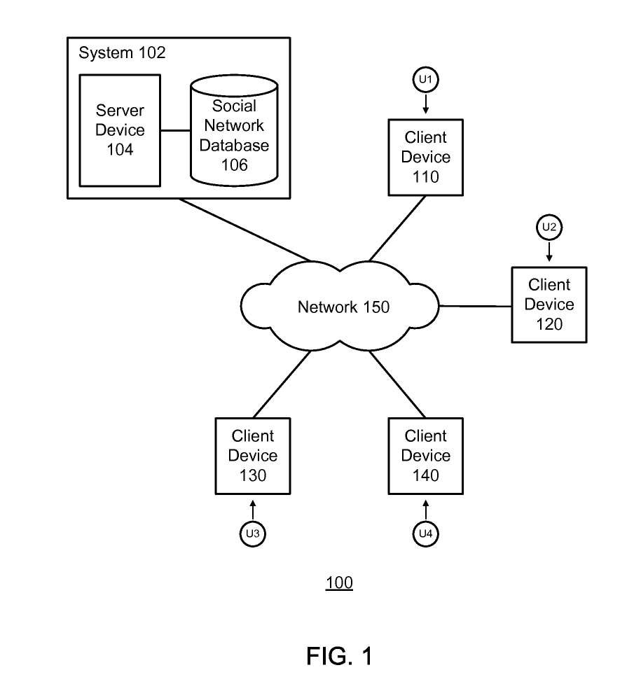

FIG. 1 illustrates a block diagram of an example network environment 100, which may be used to implement the implementations described herein. In some implementations, network environment 100 includes a system 102, which includes a server device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with each other using respective client devices 110, 120, 130, and 140. For example, users U1, U2, U3, and U4 may interact with each other in a multi-user video conference, where respective client devices 110, 120, 130, and 140 transmit media streams to each other.

In the various implementations described herein, processor of system 102 causes the elements described herein (e.g., access lists, media streams, etc.) to be displayed in a user interface on one or more display screens.

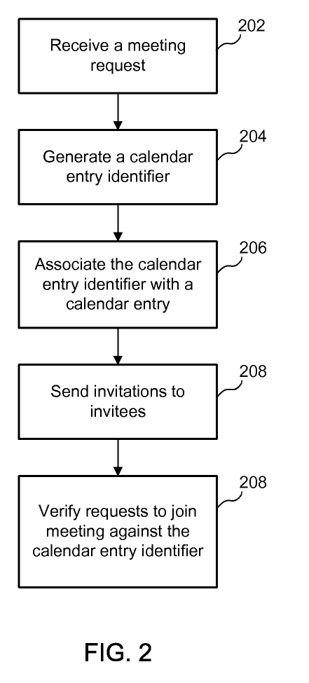

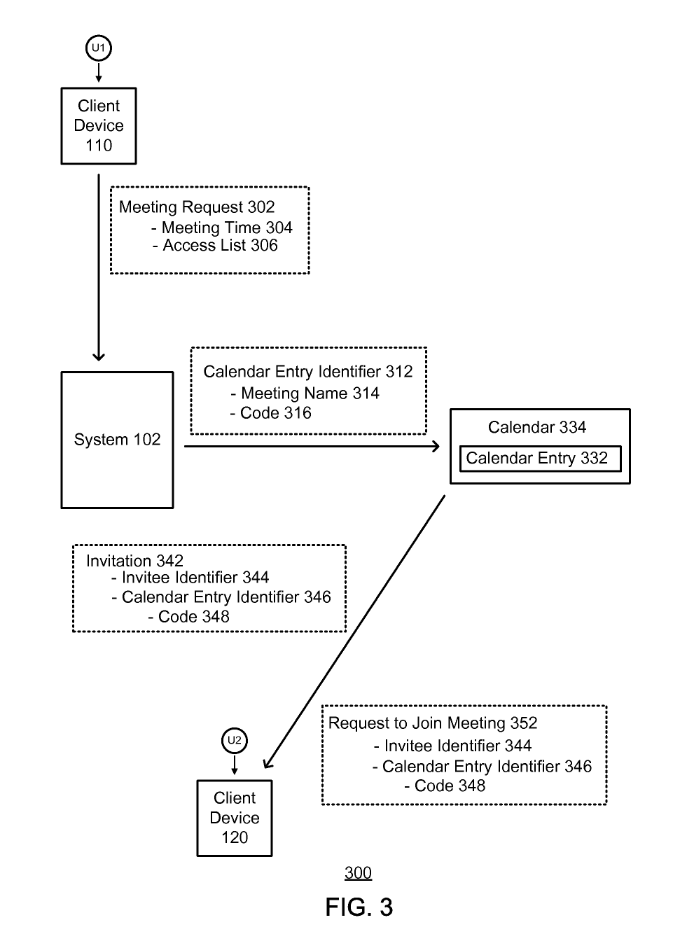

FIG. 2 illustrates an example simplified flow diagram for facilitating meetings, according to some implementations. FIG. 3 illustrates a data flow diagram, according to some implementations. Referring to both FIGS. 2 and 3, a method is initiated in block 202, where system 102 receives a meeting request 302 for a meeting. In various implementations, system 102 receives a meeting request from a user (e.g., user U1) organizing the meeting, where the meeting request includes a meeting time 304 and an access list 306. The user organizing the meeting may be referred to as the meeting organizer or meeting initiator. The meeting initiator may use any suitable electronic device (e.g., computer, laptop, tablet, smartphone, etc.) to set up a meeting.

In various implementations, the access list includes a meeting initiator (e.g., user U1) and one or more invitees (e.g., user U2) that the meeting initiator specifies. Each meeting name is associated with a different access list. The access list may also be referred to as an access control list (ACL). In some implementations, the meeting is a video conference. In some implementations, the meeting is a video chat.

In block 204, system 102 generates a calendar entry identifier 312 in response to meeting request 302. In some implementations, calendar entry identifier 312 includes a meeting name 314 and a code 316. In some embodiments, the meeting name may be based on the meeting request. For example, system 102 may name the meeting based on the meeting initiator (e.g., “Matt's meeting”). In another example, if the meeting is a weekly meeting have the same or similar group of participants, system 102 may name the meeting “Weekly meeting.” While system 102 automatically generates a meeting name, system 102 may also enable the meeting initiator to change the meeting name as desired.

In various implementations, a given meeting name may be a string of characters that identify the meeting. This has a benefit of being intuitive, as well as convenient for the users. For example, in a physical conference room, a meeting participant may type the meeting name (e.g., “Matt's meeting”) into a video conference device, and, in response, the video conference device connects to the meeting. In some implementations, system 102 creates names for particular organizations and keeps a separate namespace for each organization. This avoids meeting collisions between domains.

In block 206, system 102 associates calendar entry identifier 312 with a calendar entry 332 of a calendar 334. As described in more detail below, this enables meetings to be set up and coordinated via a calendar system. For ease of illustration, calendar 334 is shown separately from system 102. In various implementations, calendar 334 may be any suitable calendaring system that system 102 can access. Calendar 334 may be separate from system 102 or integrated with system 102.

In block 208, system 102 sends one or more invitations 342 to one or more respective invitees (e.g., user U2), where each invitation includes an invitee identifier 344 and calendar entry identifier 346 to be verified. For example, as described below, invitee identifier 344 will be verified as to whether it matches an invitee on access list 306, and calendar entry identifier 346 will be verified as to whether it matches calendar entry identifier 312 that is associated with calendar entry 332. In various implementations, the invitees correspond to invitees in the access list, and each invitee identifier corresponds to a different invitee. In some embodiments, each invitation includes link (e.g., a link to a URL). When a given invitee sees the invitation and clicks on link, the link takes user into the named meeting. In some implementations, the link takes the user into the named meeting via the calendar system of system 102.

In block 210, system 102 verifies one or more requests 352 to join the meeting against the calendar entry identifier 312. In various implementations, each request to join the meeting includes an invitee identifier and a calendar entry identifier to be verified. In various implementations, the invitee identifier is an email address.

In various implementations, the calendar entry identifier 344 in invitation 342 and in request 352 to join the meeting include a code 348 is verified against the code 316 associated with the calendar entry identifier 312. In various implementations, system 102 performs this verification if the invitee is an external invitee. In various implementations, system 102 verifies the code via the calendar system associated with system 102.

When system 102 receives request 352 to join the meeting, where request 352 is from an external invitee (e.g., user U2), system 102 reads code 348 in the calendar entry identifier 346. System 102 then compares code 348 in calendar entry identifier 346 in request 352 to join the meeting to code 316 in calendar entry identifier 312 associated with calendar entry 332 associated with the meeting. If there is a match, calendar entry identifier 344 in the request is verified, and system 102 may allow that invitee (e.g., user U2) to join the meeting. If there is no match, calendar entry identifier 344 in the request is not verified, and system 102 would not allow that invitee to join the meeting.

As described in more detail below, in various implementations, system 102 enables the meeting initiator to invite invitees to join the meeting and later un-invite particular invitees for various reasons. This is particularly applicable to external invitees (e.g., invitees who are working at a different organization or company from the meeting initiator).

In various implementations, system 102 enables the meeting initiator to control invitee access to the meeting by modifying an access list associated with the calendar entry. In some implementations, to the modify the access list, system 102 enables the meeting initiator to add or remove one or more invitees from the access list. For example, if the meeting initiator invited a particular person (e.g., Sarah) to a meeting but then later decided that the invitation was a mistake or that for some reason that person is not needed at the meeting, system 102 may allow the meeting initiator to simply remove that person from the access list (invitee list). Later, if that person tried to join the meeting, system 102 check the invitee identifier in the request to join against the invitees in the access list. There would be no match, system 102 would not allow that person to join the meeting.

If the meeting initiator instead wanted to invite a different person (e.g., James), the meeting initiator could simply add the other person's invitee identifier (e.g., email address) to the access list. That other person would receive invitation. The invitation would be the same. The difference would be that James' invitee identifier would be on access list associated with the calendar entry where sarah's invitee identifier would not.

Implementations described herein have an advantage over conventional solutions, where a dial-in or bridge number along with a conference or access code is used to enable invitees to join a meeting. With such solutions, a given invitee can still use the same dial-in number and conference code to access other meetings where that invitee is not invited. With the implementations described herein, the access list is

As described in more detail below, in various implementations, system 102 enables the meeting initiator or other invitees who are in the same organization (e.g., same company) to allow particular external invitees to join a given meeting yet later remove access to the meeting for various reasons.

In some implementations, system 102 notifies the meeting initiator and one or more internal invitees of any one or more external invitees requesting to join the meeting. For example, the notification may state, “External person Sarah wants to join this meeting.” System 102 enables the meeting initiator and any one or more of the internal invitees to approve or reject one or more requests to join the meeting.

In some implementations, system 102 enables the meeting initiator and any one or more of the internal invitees to remove access to the meeting for any one or more external invitees even after the one or more external invitees has already joined the meeting.

For example, there may be some scenarios where the internal participants (e.g., meeting initiator and the internal invitees) do not recognize the invitee identification in the request to join. This could be the case where the meeting initiator used a business email address to invite a given invitee but that invitee used a personal email address when requesting to join the meeting. In another scenario, the meeting initiator may only know an invitees personal email address and use that address for the invitation. That invitee might use his or her business email address when requesting to join the meeting. In either scenario, the meeting initiator and the internal participants might not recognize the email address and might decide to approve the request anyway to see who the person is. If they confirm that the person joining is indeed on the invitee list (access list).

In various implementations, system 102 enables the meeting initiator to add invitees to the access list by entering email address. System 102 may determine whether a given invitee is an external invitee or an internal invitee based on the email address (e.g., the domain name portion of the email address). As such, system 102 may treat a given invitee accordingly. For example, for internal invitees, system 102 may simply enable internal invitees to enter a meeting name (e.g., “Matt's meeting”) to join a meeting. In various implementations, for external invitees, system 102 requires that the code provided in the request to join the meeting match the code associated with the calendar entry in order to join the meeting.

Implementations described herein provide various benefits. For example, embodiments minimize meeting collisions within a domain. Embodiments also maintaining control of meeting access by external participants. Embodiments also enables the meeting initiator and some participants to approve or reject some requests to join a meet, which controls spam abuse.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

As indicated above, implementations enable a user, via system 102, to modify frames of different types of streams (e.g., video streams, audio streams, etc.) and streams being transmitted in different directions (e.g., outbound streams and/or inbound streams).

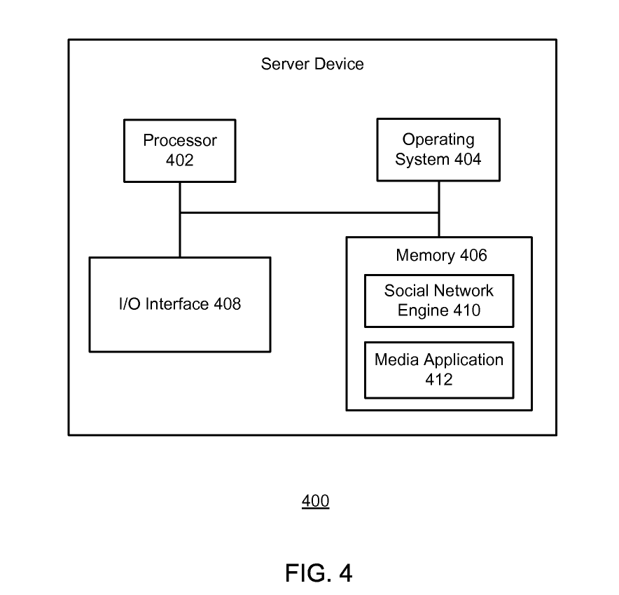

FIG. 4 illustrates a block diagram of an example server device 400, which may be used to implement the implementations described herein. For example, server device 400 may be used to implement server device 104 of FIG. 1, as well as to perform the method implementations described herein. In some implementations, server device 400 includes a processor 402, an operating system 404, a memory 406, and an input/output (I/O) interface 408. Server device 400 also includes a social network engine 410 and a media application 412, which may be stored in memory 406 or on any other suitable storage location or computer-readable medium. Media application 412 provides instructions that enable processor 402 to perform the functions described herein and other functions.

For ease of illustration, FIG. 4 shows one block for each of processor 402, operating system 404, memory 406, I/O interface 408, social network engine 410, and media application 412. These blocks 402, 404, 406, 408, 410, and 412 may represent multiple processors, operating systems, memories, I/O interfaces, social network engines, and media applications. In other implementations, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a social network system. However, the implementations described herein may apply in contexts other than a social network. For example, implementations may apply locally for an individual user.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions for execution by the processor. The software instructions can also be contained in, and provided as, an electronic signal, for example in the form of software as a service (SaaS) delivered from a server (e.g., a distributed system and/or a cloud computing system).

1-4. (canceled)

5. A method comprising:
receiving, from a client device, a meeting request for a meeting, wherein the meeting request is associated with an organization;
determining an organization name for the organization based on the meeting request;
determining whether the organization is a new organization based on the meeting request;
responsive to the organization being a new, assigning a name and a namespace to the organization;
generating, by one or more processors, a calendar entry identifier in response to the meeting request, wherein the calendar entry identifier comprises a meeting name based on the organization name;
querying a calendar server for information about a calendar entry, wherein the calendar server comprises a first processor and a memory that stores the information about the calendar entry;
associating, by the one or more processors, the calendar entry identifier with the calendar entry based on the information about the calendar entry from the calendar server;
enabling one or more internal invitees to join the meeting by providing the meeting name;
verifying, by the one or more processors, one or more requests to join the meeting against the calendar entry identifier associated with the calendar entry, wherein, for each request, the verifying comprises:
matching an invitee identifier of the respective request against a corresponding invitee identifier on an access list associated with the meeting name; and
matching the calendar entry identifier of the respective request against the calendar entry identifier associated with the calendar entry;
notifying a meeting initiator and the one or more internal invitees of an external invitee requesting to join the meeting; and
enabling the meeting initiator and any of the one or more internal invitees to approve or reject one or more requests to join the meeting.

6. The method of claim 5, wherein each request to join the meeting comprises an invitee identifier corresponding to a respective invitee and a calendar entry identifier corresponding to a respective calendar entry.

7. The method of claim 5, wherein the calendar entry identifier comprises a code.

8. The method of claim 5, wherein the calendar entry identifier associated with the calendar entry comprises a code, and wherein the code is verified against the calendar entry identifier if the invitee identifier corresponds to the external invitee.

9. The method of claim 5, further comprising enabling the meeting initiator to control invitee access to the meeting by modifying the access list.

10. The method of claim 5, further comprising enabling the meeting initiator to control invitee access to the meeting by modifying the access list wherein the modifying of the access list includes adding or removing one or more invitee identifiers from the access list.

11. The method of claim 5, further comprising sending one or more invitations to one or more respective invitees, wherein each invitation includes an invitee identifier and the calendar entry identifier.

12. The method of claim 5, further comprising:
determining that one or more requests are not verified against the calendar entry identifier associated with the calendar entry; and
prohibiting the one or more internal invitees from joining the meeting.

13. The method of claim 5, further comprising:
enabling the meeting initiator and any one or more of the internal invitees to remove access to the meeting for the external invitees even after the external invitees has already joined the meeting.

14. A system comprising:
one or more processors; and
logic encoded in one or more tangible media for execution by the one or more processors and when executed operable to perform operations comprising:
receiving a meeting request for a meeting, wherein the meeting request is associated with an organization;
determining an organization name for the organization based on the meeting request;
determining whether the organization is a new organization based on the meeting request;
responsive to the organization being new, assigning a name and a namespace to the organization;
generating a calendar entry identifier in response to the meeting request based on the organization name;
querying a calendar server for information about a calendar entry, wherein the calendar server comprises a first processor and a memory that stores the information about the calendar entry;
associating, by the one or more processors, the calendar entry identifier with the calendar entry based on the information about the calendar entry from the calendar server;
verifying one or more requests to join the meeting against the calendar entry identifier associated with the calendar entry, wherein, for each request, the verifying comprises:
matching an invitee identifier of the respective request against a corresponding invitee identifier on an access list associated with the meeting; and
matching calendar entry identifier of the respective request against the calendar entry identifier associated with the calendar entry;
notifying a meeting initiator and one or more internal invitees of an external invitee requesting to join the meeting; and
enabling the meeting initiator and any of the one or more internal invitees to approve or reject one or more requests to join the meeting.

15. The system of claim 14, wherein each request to join the meeting comprises an invitee identifier corresponding to a respective invitee and a calendar entry identifier corresponding to a respective calendar entry.

16. The system of claim 14, wherein the calendar entry identifier comprises a code.

17. The system of claim 14, wherein the calendar entry identifier associated with the calendar entry comprises a code, and wherein the code is verified against the calendar entry identifier if the invitee identifier corresponds to the external invitee.

18. The system of claim 14, wherein the logic when executed is further operable to perform operations comprising enabling the meeting initiator to control invitee access to the meeting by modifying the access list.

19. The system of claim 14, wherein the logic when executed is further operable to perform operations comprising enabling the meeting initiator to control invitee access to the meeting by modifying the access list, wherein the modifying of the access list includes adding or removing one or more invitee identifiers from the access list.

20. The system of claim 14, wherein the logic when executed is further operable to perform operations comprising sending one or more invitations to one or more respective invitees, wherein each invitation includes the invitee identifier and the calendar entry identifier.

21. A non-transitory computer storage medium encoded with a computer program, the computer program comprising instructions that, when executed by one or more computers, cause the one or more computers to perform operations comprising:
receiving, from a client device, a meeting request for a meeting, wherein the meeting request is associated with an organization;
determining an organization name for the organization based on the meeting request;
determining that the organization is a new organization based on the meeting request;
assigning a name and a namespace to the organization based on the organization name;
generating, by one or more processors, a calendar entry identifier in response to the meeting request, wherein the calendar entry identifier comprises a meeting name based on the organization name;
querying a calendar server for information about a calendar entry, wherein the calendar server comprises a first processor and a memory that stores the information about the calendar entry;
associating, by the one or more processors, the calendar entry identifier with the calendar entry based on the information about the calendar entry from the calendar server;
enabling one or more internal invitees to join the meeting by providing the meeting name;
verifying, by the one or more processors, one or more requests to join the meeting against the calendar entry identifier associated with the calendar entry, wherein, for each request, the verifying comprises:
matching an invitee identifier of the respective request against a corresponding invitee identifier on an access list associated with the meeting name; and
matching the calendar entry identifier of the respective request against the calendar entry identifier associated with the calendar entry;
notifying a meeting initiator and the one or more internal invitees of an external invitee requesting to join the meeting; and
enabling the meeting initiator and any of the one or more internal invitees to approve or reject one or more requests to join the meeting.

22. The computer storage medium of claim 21, wherein each request to join the meeting comprises an invitee identifier corresponding to a respective invitee and a calendar entry identifier corresponding to a respective calendar entry.

23. The computer storage medium of claim 21, wherein the computer program further comprises comprising instructions to perform operations comprising:
enabling the meeting initiator to control invitee access to the meeting by modifying the access list to add or remove one or more invitee identifiers from the access list.

24. The computer storage medium of claim 23, wherein the computer program further comprises comprising instructions to perform operations comprising:
receiving an invitee request to add the external invitee to the access list, the invitee request including a domain associated with the external invitee;
determining, based on the domain associated with the external invitee, that the external invitee is external to the organization associated with the meeting initiator; and
sending an invitation to the external invitee.

25. The computer storage medium of claim 21, wherein the computer program further comprises comprising instructions to perform operations comprising:
sending one or more invitations to one or more respective invitees, wherein each invitation includes the invitee identifier and the calendar entry identifier.
